(19) United States
(12) Patent Application Publication
(10) Pub. No.: US 2025/0388225 A1
(43) Pub. Date: Dec. 25, 2025

(54) ANTI-WHEELIE CONTROLLER AND ANTI-WHEELIE CONTROL METHOD

(71) Applicant: KAWASAKI MOTORS, LTD., Akashi-shi (JP)

(72) Inventor: Kosuke OBAYASHI, Kobe-shi (JP)

(21) Appl. No.: 19/228,197

(22) Filed: Jun. 4, 2025

(30) Foreign Application Priority Data
Jun. 21, 2024 (JP) 2024-100058

(51) Int. Cl. B60W 50/08; B60W 30/02; B60W 40/09

(52) U.S. Cl. CPC B60W 50/087; B60W 30/02; B60W 40/09; B60W 2300/36; B60W 2540/103

(57) ABSTRACT

Processing circuitry is configured to: calculate rider request torque; determine whether or not the rider request torque has exceeded at least one threshold; and when it is determined that the rider request torque has exceeded the threshold, correct the rider request torque so as to reduce the rider request torque.

### CROSS-REFERENCE TO RELATED APPLICATION

This application claims priority to and the benefit of Japanese Patent Application No. 2024-100058 filed on Jun. 21, 2024, the entire disclosure of which is incorporated herein by reference.

### BACKGROUND OF THE INVENTION

### Field of the Invention

The present disclosure relates to an anti-wheelie controller and an anti-wheelie control method.

### Description of the Related Art

Japanese Laid-Open Patent Application Publication No. 2021-38709 discloses a torque suppression controller that suppresses the occurrence of a wheelie of a motorcycle. When this controller determines that a first condition that a traveling state of the motorcycle is a wheelie state has been satisfied, the controller executes first control that suppresses the output of a prime mover. On the other hand, when the controller determines that the first condition has not been satisfied, but a second condition that the traveling state of the motorcycle is a pre-wheelie state has been satisfied, the controller executes second control that limits an output change speed corresponding to an operation input.

However, since the above controller performs feedback control of the prime mover in accordance with the degree of wheelie while monitoring the traveling state of the motorcycle, such control is complex.

### SUMMARY OF THE INVENTION

One aspect of the present disclosure is to effectively prevent the occurrence of the wheelie by simple control.

An anti-wheelie controller according to one aspect of the present disclosure is an anti-wheelie controller that prevents a wheelie of a vehicle. The anti-wheelie controller includes processing circuitry configured to: calculate rider request torque; determine whether or not the rider request torque has exceeded at least one threshold; and when it is determined that the rider request torque has exceeded the threshold, correct the rider request torque so as to reduce the rider request torque.

An anti-wheelie control method according to one aspect of the present disclosure is an anti-wheelie control method of preventing a wheelie of a vehicle. The anti-wheelie control method includes: calculating rider request torque; determining whether or not the rider request torque has exceeded at least one threshold; and when it is determined that the rider request torque has exceeded the threshold, correcting the rider request torque so as to reduce the rider request torque.

### BRIEF DESCRIPTION OF THE DRAWINGS

FIG. 1 is a left side view of a motorcycle according to an embodiment.

FIG. 2 is a schematic diagram of a power system of the motorcycle of FIG. 1.

FIG. 3 is a block diagram of a controller of FIG. 2.

FIG. 4 is a flowchart showing processing of the controller of FIG. 3.

FIG. 5 is a graph showing a relation between an accelerator operation amount and rider request torque.

### DESCRIPTION OF THE PREFERRED EMBODIMENTS

Hereinafter, an embodiment will be described with reference to the drawings. In the present embodiment, a motorcycle 1 will be described as a vehicle including a controller 20 having an anti-wheelie control function. The motorcycle 1 is an example of a lean vehicle that turns while leaning in a lateral direction. The vehicle is not limited to the motorcycle 1 and may be a three-wheeled vehicle or a four-wheeled vehicle.

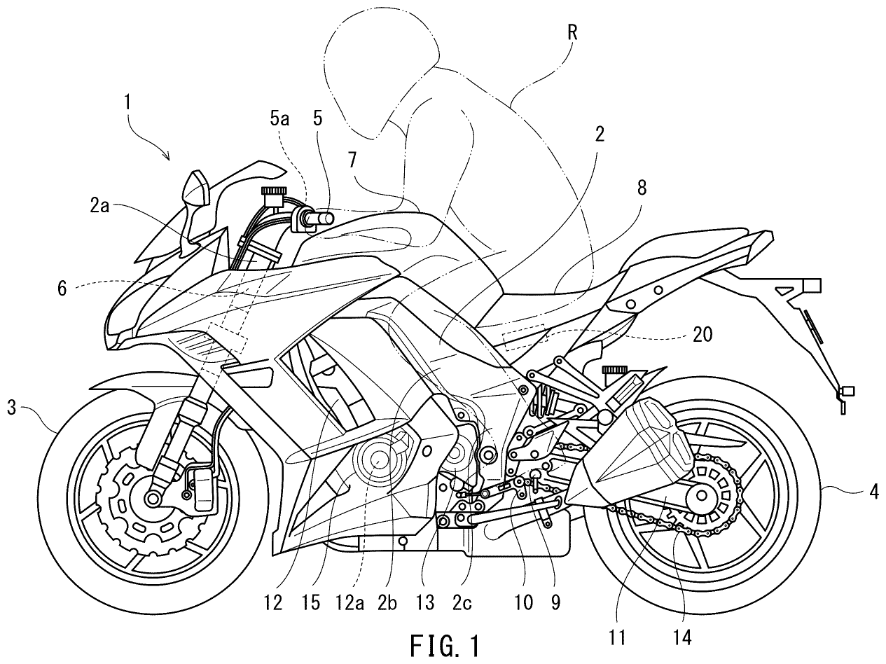

FIG. 1 is a left side view of the motorcycle 1. As shown in FIG. 1, the motorcycle 1 includes a vehicle body frame 2, a front wheel 3, and a rear wheel 4. The front wheel 3 and the rear wheel 4 are supported by the vehicle body frame 2. The front wheel 3 is a driven wheel, and the rear wheel 4 is a driving wheel. The vehicle body frame 2 includes: a head pipe 2a; a main frame 2b extending rearward from the head pipe 2a; and a pivot frame 2c connected to a rear portion of the main frame 2b. The head pipe 2a turnably supports a steering shaft 6 connected to a handlebar 5 held by a rider R with his/her hands. The front wheel 3 is steered to the left or the right by the turning of the steering shaft 6. A right grip of the handlebar 5 is an accelerator grip 5a to which an acceleration request of the rider R is input when the rider R rotates the accelerator grip 5a with his/her hand.

A fuel tank 7 is located behind the handlebar 5 and vertically above the main frame 2b. A seat 8 straddled and ridden by the rider R is located behind the fuel tank 7. A step 9 on which the rider R puts his/her foot is located under the seat 8. A shift lever 10 operated by the foot put on the step 9 is located in the vicinity of the step 9. A front end portion of a swing arm 11 is pivotally supported by the pivot frame 2c, and the rear wheel 4 is pivotally supported by a rear end portion of the swing arm 11.

An internal combustion engine 12 supported by the main frame 2b and the pivot frame 2c is located between the front wheel 3 and the rear wheel 4. The internal combustion engine 12 is an example of a prime mover that generates traveling driving force. The prime mover of the motorcycle 1 is not limited to the internal combustion engine 12 and may be an electric motor or a combination of the electric motor and the internal combustion engine.

A crank shaft 12a of the internal combustion engine 12 is connected to a transmission 13 so as to be able to transmit power to the transmission 13. The driving force output from the transmission 13 is transmitted to the rear wheel 4 through a power transmitting structure 14, such as a chain, a belt, or a drive shaft. The crank shaft 12a of the internal combustion engine 12 is accommodated in a crankcase 15 supported by the vehicle body frame 2. The crankcase 15 also accommodates the transmission 13 and also serves as a transmission case. The motorcycle 1 includes the controller 20 that controls the internal combustion engine 12.

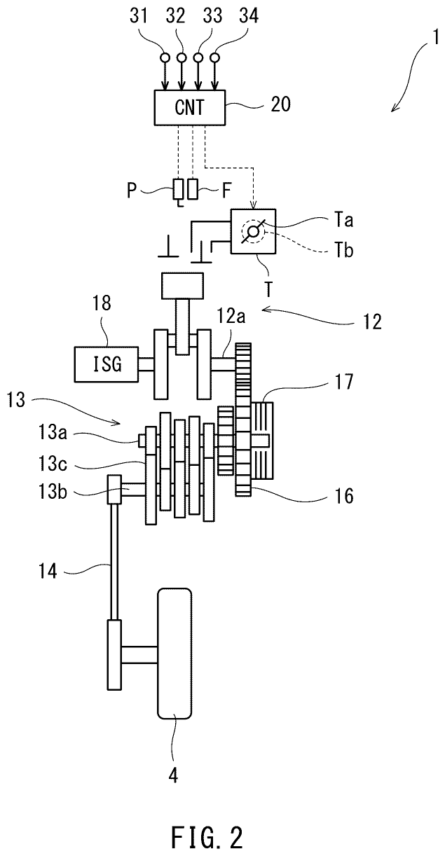

FIG. 2 is a schematic diagram of a power system of the motorcycle 1 of FIG. 1. As shown in FIG. 2, throttle equipment T, a fuel injector F, and an ignition plug P are located at the internal combustion engine 12. The throttle equipment T includes a throttle valve Ta and a throttle actuator Tb. The throttle valve Ta adjusts an intake air amount of the internal combustion engine 12, and the throttle actuator Tb drives the throttle valve Ta to adjust a throttle opening degree. The throttle actuator Tb may be an electric motor. The fuel injector F injects fuel, stored in the fuel tank 7, to an intake passage of the internal combustion engine 12. The ignition plug P ignites a fuel-air mixture in a combustion chamber of the internal combustion engine 12.

One end portion of the crank shaft 12a of the internal combustion engine 12 is connected to a primary gear 16 so as to be able to transmit power to the primary gear 16. The other end portion of the crank shaft 12a is connected to a starter generator 18 so as to be able to transmit power to the starter generator 18. The transmission 13 includes an input shaft 13a, an output shaft 13b, and gear trains 13c having different reduction ratios. In the transmission 13, power is transmitted from the input shaft 13a to the output shaft 13b through one gear train 13c selected arbitrarily. A gear position of the transmission 13 is stepwisely selectable in a range from a first-speed position to an N-th-speed position (N is a natural number of two or more). The transmission 13 changes the reduction ratio by stepwisely changing the gear position in the range from the first-speed position having a maximum reduction ratio to the N-th-speed position having a minimum reduction ratio.

The crank shaft 12a is connected to a main clutch 17 through the primary gear 16 so as to be able to transmit power to the main clutch 17. The main clutch 17 is a friction clutch. The main clutch 17 is connected to the input shaft 13a. The crank shaft 12a transmits power to the input shaft 13a of the transmission 13 through the primary gear 16 and the main clutch 17. The driving force output from the output shaft 13b of the transmission 13 drives the rear wheel 4 through the power transmitting structure 14.

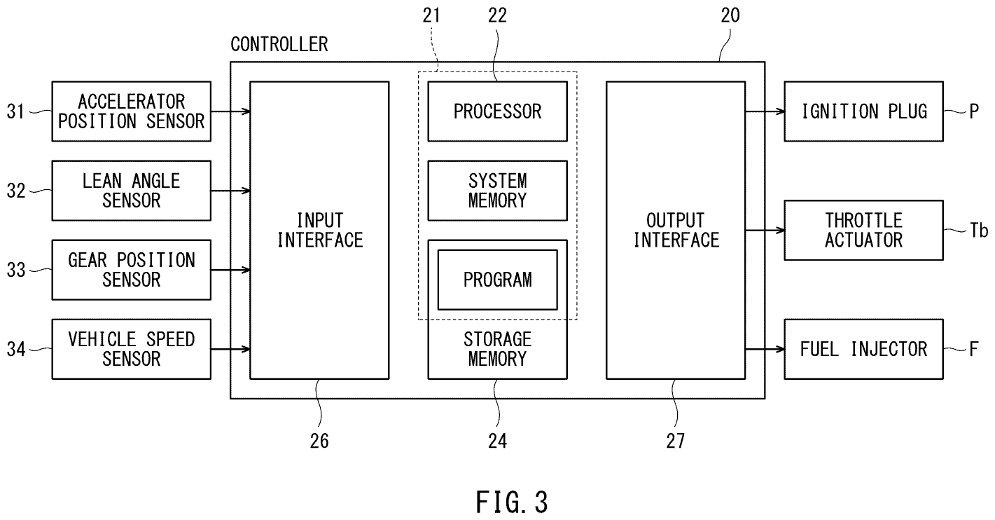

FIG. 3 is a block diagram of the controller 20 of FIG. 2. As shown in FIG. 3, the controller 20 includes processing circuitry 21. Specifically, the controller 20 includes a processor 22, a system memory 23, a storage memory 24, an input interface 26, and an output interface 27. The processor 22 may include a CPU (Central Processing Unit). The system memory 23 may include a RAM (Random Access Memory). The storage memory 24 may include a hard disk, a flash memory, or a combination thereof. The storage memory 24 stores a program 25. A configuration in which the processor 22 executes the program 25 read out from the storage memory 24 into the system memory 23 is one example of the processing circuitry 21.

An accelerator position sensor 31, a lean angle sensor 32, a gear position sensor 33, and a vehicle speed sensor 34 are communicably connected to the input interface 26 of the controller 20. The accelerator position sensor 31 detects a rotation angle of the accelerator grip 5a to detect an operation amount of the accelerator grip 5a operated by the rider R, i.e., an accelerator operation amount. The lean angle sensor 32 detects an inclination angle of the motorcycle 1 in the lateral direction, i.e., a lean angle. The lean angle sensor 32 may also be called a bank angle sensor. The lean angle sensor 32 may be, for example, a gyro sensor. The gear position sensor 33 detects the gear position of the transmission 13. To be specific, the gear position sensor 33 detects one gear train 13c which has been engaged with the input shaft 13a and the output shaft 13b among the gear trains 13c of the transmission 13. The vehicle speed sensor 34 detects a traveling speed of the motorcycle 1. The vehicle speed sensor 34 may be, for example, a sensor that detects a rotational speed of the front wheel 3.

The ignition plug P, the throttle actuator Tb, and the fuel injector F are communicably connected to the output interface 27 of the controller 20. The controller 20 controls at least one of the ignition plug P, the throttle actuator Tb, or the fuel injector F based on at least a detected value of the accelerator position sensor 31. For example, the controller 20 controls at least one of the ignition plug P, the throttle actuator Tb, or the fuel injector F based on the detected value of the accelerator position sensor 31 and at least one of the detected value of the lean angle sensor 32, the detected value of the gear position sensor 33, or the detected value of the vehicle speed sensor 34.

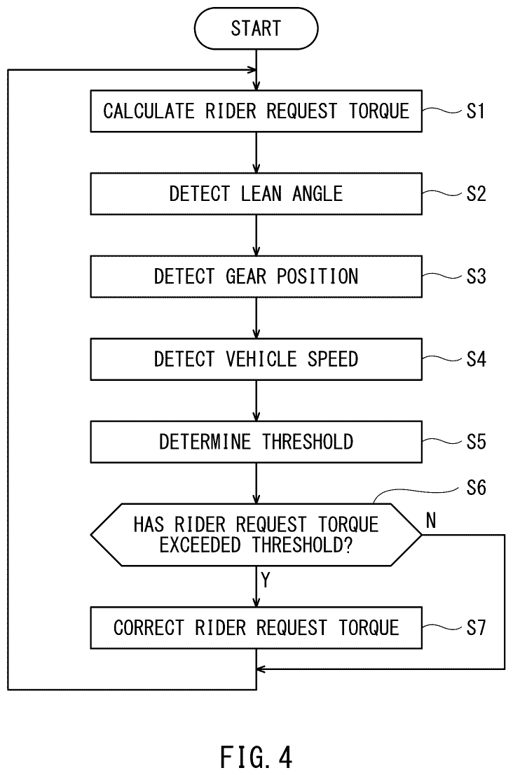

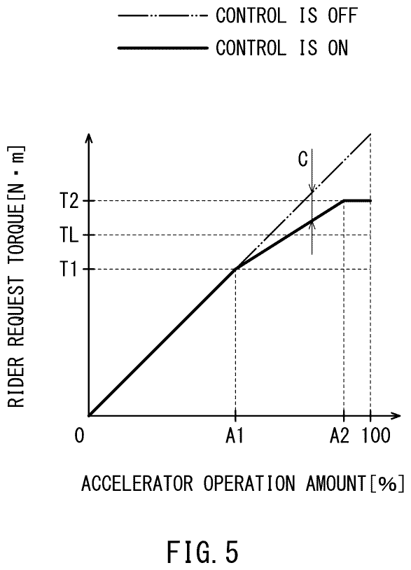

FIG. 4 is a flowchart showing processing of the controller 20 of FIG. 3. FIG. 5 is a graph showing a relation between the accelerator operation amount and rider request torque. Hereinafter, the processing of the controller 20 will be described based on the flow of FIG. 4 with suitable reference to FIGS. 1 to 3 and 5. The processing of the controller 20 is executed by the processing circuitry 21. The controller 20 is an example of an anti-wheelie controller that can prevent the occurrence of a wheelie. For example, the controller 20 may turn on or off the anti-wheelie control function by the selection of the rider R. When the anti-wheelie control function is turned on, the control of FIG. 4 starts.

The controller 20 calculates the rider request torque based on the detected value of the accelerator position sensor 31 (Step S1). The rider request torque increases in accordance with an increase in the accelerator operation amount detected by the accelerator position sensor 31. The controller 20 may calculate the rider request torque by using a function formula by which the rider request torque increases in accordance with the increase in the accelerator operation amount detected by the accelerator position sensor 31. The controller 20 may calculate the rider request torque with reference to a torque map in which a correlation between the accelerator operation amount and the rider request torque is specified in advance. The controller 20 may calculate the rider request torque by additionally referring to information other than the accelerator operation amount.

The controller 20 detects the lean angle of the motorcycle 1 with reference to the detected value of the lean angle sensor 32 (Step S2). For example, when the motorcycle 1 stands upright, the lean angle is zero. The lean angle increases as the motorcycle 1 leans in the lateral direction while turning. The controller 20 detects the gear position of the transmission 13 with reference to the detected value of the gear position sensor 33 (Step S3). The controller 20 detects the traveling speed of the motorcycle 1 with reference to the detected value of the vehicle speed sensor 34 (Step S4). For convenience of explanation, Steps S1 to S5 have been described so as to be executed in this order. However, Steps S1 to S5 may be executed simultaneously or may be executed in any order. Moreover, at least one or all of Steps S2 to S4 may be omitted.

The controller 20 determines a first threshold T1 and a second threshold T2 with which the rider request torque is compared (Step S5). The second threshold T2 is larger than the first threshold T1. The number of thresholds with which the rider request torque is compared is not limited to two and may be only one or may be three or more.

As shown in FIG. 5, the first threshold T1 and the second threshold T2 may be set such that wheelie limit torque TL determined from the specifications of the motorcycle 1 becomes a value between the first threshold T1 and the second threshold T2. The wheelie limit torque TL denotes torque of the internal combustion engine 12 which makes the motorcycle 1 start the wheelie. The wheelie limit torque TL is converted from wheelie limit driving force FL. The wheelie limit driving force FL denotes driving force of the rear wheel 4 which makes the motorcycle 1 start the wheelie. The wheelie limit driving force FL can be calculated by Formula 1 below.

$$\begin{matrix}Formula 1 & \\ FL = Fz \cdot b / h & ( 1 )\end{matrix}$$

Here, Fz represents force that acts in a vehicle body upper-lower direction Z from the motorcycle 1 to a ground surface. Moreover, b represents a distance from a center of the rear wheel 4 to the center of gravity of the motorcycle 1 in a front-rear direction of the motorcycle 1. The distance b is a constant determined in accordance with the type of the vehicle. Furthermore, h represents the height of the center of gravity of the motorcycle 1 from the ground surface.

The vehicle body upper-lower direction force Fz can be calculated by Formula 2 below.

$$\begin{matrix}Formula 2 & \\ Fz = m \cdot g \cdot cos θ + Fc \cdot sin θ & ( 2 )\end{matrix}$$

Here, m represents the total of the weight of the motorcycle 1 and the weight of the rider R. The weight of the motorcycle 1 is a constant determined in accordance with the type of the vehicle. The weight of the rider R may be a constant predetermined with reference to the typical weight of a human or may be measured by a weight sensor incorporated in the seat 8. Moreover, g represents gravitational acceleration. Furthermore, θ represents the lean angle detected by the lean angle sensor 32, and Fc represents centrifugal force that acts on the motorcycle 1 that is turning. A table showing a relation between the lean angle θ and the wheelie limit driving force FL may be prestored in the storage memory 24, and the wheelie limit driving force FL corresponding to the lean angle θ detected by the lean angle sensor 32 may be read out from the table.

The reduction ratio of a power transmitting path from the internal combustion engine 12 to the rear wheel 4 in the motorcycle 1 is represented by U, and rotary inertial resistance of the power transmitting path from the internal combustion engine 12 to the rear wheel 4 in the motorcycle 1 is represented by V. The wheelie limit torque TL is converted from the wheelie limit driving force FL by Formula 3 below.

$$\begin{matrix}Formula 3 & \\ TL = FL \cdot V / U & ( 3 )\end{matrix}$$

Thus, as compared to when the wheelie limit torque TL is calculated backward from the wheelie limit driving force FL by using only the reduction ratio U, the loss of the rotary inertial resistance V is added, and therefore, the wheelie limit driving force FL is prevented from being excessively underestimated.

Each of the first threshold T1 and the second threshold T2 may be a variable threshold. The first threshold T1 may be determined so as to increase in accordance with the increase in the lean angle detected by the lean angle sensor 32. The first threshold T1 may be determined so as to decrease in accordance with the increase in a time increasing rate of the accelerator operation amount detected by the accelerator position sensor 31. The first threshold T1 may be determined so as to decrease as the gear position of the transmission 13 which is detected by the gear position sensor 33 changes to a lower position. The first threshold T1 may be determined so as to increase in accordance with the increase in the traveling speed detected by the vehicle speed sensor 34.

The first threshold T1 does not have to be determined based on all of the lean angle, the time increasing rate of the accelerator operation amount, the gear position of the transmission 13, and the traveling speed. The first threshold T1 may be determined in accordance with information that is at least one selected from the group consisting of the lean angle, the time increasing rate of the accelerator operation amount, the gear position of the transmission 13, and the traveling speed. The first threshold T1 may be constant.

The second threshold T2 may be determined so as to change in proportion to a change amount of the first threshold T1. The second threshold T2 may be determined so as to change by a change amount that is equal to the change amount of the first threshold T1. The second threshold T2 may be constant.

Next, the controller 20 determines whether or not the rider request torque has exceeded the first threshold T1 (Step S6). When the controller 20 determines that the rider request torque has not exceeded the first threshold T1 (No in Step S6), the controller 20 does not correct the rider request torque. When the controller 20 determines that the rider request torque has exceeded the first threshold T1 (Yes in Step S6), the controller 20 corrects the rider request torque so as to reduce the rider request torque (Step S7).

Hereinafter, the correction of the rider request torque will be specifically described with reference to FIG. 5. In FIG. 5, a two-dot chain line shows an example in which anti-wheelie control is in an OFF state. When the anti-wheelie control is in the OFF state, the controller 20 increases the rider request torque in proportion to the increase in the accelerator operation amount in the entire range of the accelerator operation amount.

In FIG. 5, a solid line shows an example in which the anti-wheelie control is in an ON state. When the anti-wheelie control is in the ON state, the controller 20 may change a ratio of the rider request torque to the accelerator operation amount. Specifically, when the rider request torque is the first threshold T1 or less, the controller 20 sets a correction amount of the rider request torque to zero. To be specific, when the rider request torque is the first threshold T1 or less, the controller 20 sets the ratio of the rider request torque to the accelerator operation amount to the same ratio as when the anti-wheelie control is in the OFF state.

When the controller 20 determines that the rider request torque has not exceeded the second threshold T2 but has exceeded the first threshold T1, the controller 20 corrects the rider request torque such that the rider request torque becomes lower than the rider request torque when the anti-wheelie control is in the OFF state. An absolute value of a correction amount C of the rider request torque increases in accordance with the increase in the accelerator operation amount. At this time, the corrected rider request torque maintains the tendency to increase in accordance with the increase in the accelerator operation amount. To be specific, the corrected rider request torque increases as the accelerator operation amount increases from a value A1 to a value A2. While the accelerator operation amount increases from the value A1 to the value A2, the corrected rider request torque may be constant regardless of the increase in the accelerator operation amount.

When the controller 20 determines that the rider request torque has exceeded the second threshold T2, the controller 20 increases the absolute value of the correction amount C, which reduces the rider request torque, such that the absolute value of the correction amount C becomes larger than the absolute value of the correction amount C when the controller 20 determines that the rider request torque has not exceeded the second threshold T2 but has exceeded the first threshold T1. In FIG. 5, while the accelerator operation amount increases beyond the value A2, the corrected rider request torque is constant regardless of the increase in the accelerator operation amount, but may increase in accordance with the increase in the accelerator operation amount.

According to the above-described configuration, when the rider request torque is high, and therefore, the wheelie may occur, the rider request torque is corrected to be reduced, and this suppresses the increase in the driving force of the rear wheel 4. Therefore, the occurrence of the wheelie can be effectively prevented by the simple control.

Each of the first threshold T1 and the second threshold T2 may be a variable threshold that increases in accordance with the increase in the lean angle of the motorcycle 1. In this case, when the motorcycle 1 leans in the lateral direction, the center of gravity lowers, and the wheelie hardly occurs. At this time, the rider request torque is hardly corrected so as to be reduced. Therefore, the driving force of the rear wheel 4 can be suitably prevented from being unnecessarily suppressed.

When the rider request torque has not exceeded the second threshold T2 but has exceeded the first threshold T1, the correction amount C that reduces the rider request torque is small, and therefore, the feeling of the rider R can be satisfactorily maintained. When the rider request torque has exceeded the second threshold T2, the correction amount C that reduces the rider request torque is large, and therefore, the wheelie can be satisfactorily prevented. Thus, both of the satisfactory maintenance of the feeling of the rider R and the satisfactory prevention of the wheelie can be achieved.

Since the wheelie limit torque TL determined from the specifications of the motorcycle 1 is a value between the first threshold T1 and the second threshold T2, the rider R can accelerate the motorcycle 1 while paying attention to the wheelie limit torque TL, and the excess and deficiency of the torque suppression can be suppressed.

By increasing the absolute value of the correction amount C of the rider request torque in accordance with the increase in the accelerator operation amount, the occurrence of the wheelie can be surely prevented in accordance with the possibility of occurrence of the wheelie.

In the correction that reduces the rider request torque, the tendency of the increase in the rider request torque in accordance with the increase in the accelerator operation amount is maintained. Therefore, the feeling of the increase in the driving force of the rear wheel 4 in accordance with the increase in the accelerator operation amount can be given to the rider R, and thus, the feeling of the rider R can be satisfactorily maintained.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

The functionality of the elements disclosed herein may be implemented using circuitry or processing circuitry which includes general purpose processors, special purpose processors, integrated circuits, ASICs (“Application Specific Integrated Circuits”), FPGAs (“Field Programmable Gate Arrays”), GPUs (“Graphics Processing Units”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### ASPECTS

The above embodiment describes specific examples of the following aspects.

### First Aspect

An anti-wheelie controller that prevents a wheelie of a vehicle,
the anti-wheelie controller including processing circuitry configured to:
calculate rider request torque;
determine whether or not the rider request torque has exceeded at least one threshold; and
when it is determined that the rider request torque has exceeded the threshold, correct the rider request torque so as to reduce the rider request torque.

According to this configuration, when the rider request torque is high, and therefore, the wheelie may occur, the rider request torque is corrected to be reduced, and this suppresses the increase in the driving force of the driving wheel. Therefore, the occurrence of the wheelie can be effectively prevented by the simple control.

### Second Aspect

The anti-wheelie controller according to the first aspect, wherein:
the vehicle is a lean vehicle that turns while leaning in a lateral direction; and
the threshold includes a variable threshold that increases in accordance with an increase in a lean angle of the lean vehicle.

According to this configuration, when the vehicle body leans in the lateral direction such that the vehicle center of gravity lowers, and therefore, the wheelie hardly occurs, the rider request torque is hardly corrected so as to be reduced. Thus, the driving force of the driving wheel can be suitably prevented from being unnecessarily suppressed.

### Third Aspect

The anti-wheelie controller according to the first or second aspect, wherein:
the at least one threshold includes a first threshold and a second threshold larger than the first threshold; and
correcting the rider request torque includes making a correction amount when it is determined that the rider request torque has not exceeded the second threshold but has exceeded the first threshold smaller than a correction amount when it is determined that the rider request torque has exceeded the second threshold.

According to this configuration, when the rider request torque has not exceeded the second threshold but has exceeded the first threshold, the correction amount that reduces the rider request torque is small, and therefore, the feeling of the rider can be satisfactorily maintained. When the rider request torque has exceeded the second threshold, the correction amount that reduces the rider request torque is large, and therefore, the wheelie can be satisfactorily prevented. Thus, both of the satisfactory maintenance of the feeling of the rider and the satisfactory prevention of the wheelie can be achieved.

### Fourth Aspect

The anti-wheelie controller according to the third aspect, wherein the first threshold and the second threshold are set such that wheelie limit torque determined from specifications of the vehicle is a value between the first threshold and the second threshold.

According to this configuration, the rider can accelerate the motorcycle while paying attention to the wheelie limit torque, and the excess and deficiency of the torque suppression can be suppressed.

### Fifth Aspect

The anti-wheelie controller according to any one of the first to fourth aspects, wherein:
the processing circuitry is configured to acquire an accelerator operation amount of a rider; and
correcting the rider request torque includes increasing an absolute value of a correction amount of the rider request torque in accordance with an increase in the accelerator operation amount.

According to this configuration, the occurrence of the wheelie can be surely prevented in accordance with the possibility of occurrence of the wheelie.

### Sixth Aspect

The anti-wheelie controller according to any one of the first to fifth aspects, wherein:
the processing circuitry is configured to acquire an accelerator operation amount of a rider; and
correcting the rider request torque includes maintaining a tendency of an increase in the rider request torque in accordance with an increase in the accelerator operation amount.

According to this configuration, when it is determined that the rider request torque has exceeded the threshold, the tendency of the increase in the rider request torque in accordance with the increase in the accelerator operation amount is maintained while making the rider request torque lower than the rider request torque when it is not determined that the rider request torque has exceeded the threshold. Therefore, the tendency of the increase in the driving force of the driving wheel when the rider increases the accelerator operation amount can be maintained, and the feeling of the rider can be satisfactorily maintained.

### Seventh Aspect

An anti-wheelie control method of preventing a wheelie of a vehicle,
the anti-wheelie control method including:
calculating rider request torque;
determining whether or not the rider request torque has exceeded at least one threshold; and
when it is determined that the rider request torque has exceeded the threshold, correcting the rider request torque so as to reduce the rider request torque.

According to this method, when the rider request torque is high, and therefore, the wheelie may occur, the rider request torque is corrected to be reduced, and this suppresses the increase in the driving force of the driving wheel. Therefore, the occurrence of the wheelie can be effectively prevented by the simple control.

What is claimed is:

1. An anti-wheelie controller that prevents a wheelie of a vehicle,
the anti-wheelie controller comprising processing circuitry configured to:
calculate rider request torque;
determine whether or not the rider request torque has exceeded at least one threshold; and
when it is determined that the rider request torque has exceeded the threshold, correct the rider request torque so as to reduce the rider request torque.

2. The anti-wheelie controller according to claim 1, wherein:
the vehicle is a lean vehicle that turns while leaning in a lateral direction; and
the threshold includes a variable threshold that increases in accordance with an increase in a lean angle of the lean vehicle.

3. The anti-wheelie controller according to claim 1, wherein:
the at least one threshold comprises a first threshold and a second threshold larger than the first threshold; and
correcting the rider request torque includes making a correction amount when it is determined that the rider request torque has not exceeded the second threshold but has exceeded the first threshold smaller than a correction amount when it is determined that the rider request torque has exceeded the second threshold.

4. The anti-wheelie controller according to claim 3, wherein the first threshold and the second threshold are set such that wheelie limit torque determined from specifications of the vehicle is a value between the first threshold and the second threshold.

5. The anti-wheelie controller according to claim 1, wherein:
the processing circuitry is configured to acquire an accelerator operation amount of a rider; and
correcting the rider request torque includes increasing an absolute value of a correction amount of the rider request torque in accordance with an increase in the accelerator operation amount.

6. The anti-wheelie controller according to claim 1, wherein:
the processing circuitry is configured to acquire an accelerator operation amount of a rider; and
correcting the rider request torque includes maintaining a tendency of an increase in the rider request torque in accordance with an increase in the accelerator operation amount.

7. An anti-wheelie control method of preventing a wheelie of a vehicle,
the anti-wheelie control method comprising:
calculating rider request torque;
determining whether or not the rider request torque has exceeded at least one threshold; and
when it is determined that the rider request torque has exceeded the threshold, correcting the rider request torque so as to reduce the rider request torque.
